(19) United States
(12) Patent Application Publication
(10) Pub. No.: US 2007/0091018 A1
(43) Pub. Date: Apr. 26, 2007

(54) Plasma display device and method for driving the same

(75) Inventor: Jung Hyun Park, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/586,647

(22) Filed: Oct. 26, 2006

(30) Foreign Application Priority Data
Oct. 26, 2005 (KR) 10-2005-0101310

(51) Int. Cl. G09G 3/28

(52) U.S. Cl. 345/60

(57) ABSTRACT

A plasma display device is provided. The plasma display device includes an X-board, a Y-board, a Z-board, a voltage generator, and a power supply controller. The X-board outputs an address voltage to an address electrode. The Y-board outputs a scan voltage to a scan electrode. A Z-board outputs a sustain voltage to a sustain electrode. A voltage generator generates the address voltage, the scan voltage and the sustain voltage, and provides the address voltage, the scan voltage and the sustain voltage to the X-board, the Y-board and the Z-board, respectively. The power supply controller controls transmission of the address voltage, the scan voltage, and the sustain voltage to provide power to at least one of the X-board, the Y-board and the Z-board at a different time when the display device is initially driven.

### BACKGROUND OF THE INVENTION

1. Field of the Invention

The present invention relates to a plasma display device, and more particularly, to a plasma display device and a method for driving the same.

2. Description of the Related Art

In general, a plasma display device includes a scan electrode (hereinafter, referred to as a ‘Y electrode’) and a sustain electrode (hereinafter, referred to as a ‘Z-electrode’) on the same plane of an upper substrate, and an address electrode (hereinafter, referred to as an. ‘X electrode’) on a lower substrate. Also, a barrier rib is formed between the X-electrodes to prevent cross-talk, and a phosphor layer is formed around the barrier rib and the X-electrode. Also, a space between the upper substrate and the lower substrate is filled with an inert gas, thereby forming a discharge region.

Accordingly, when a driving voltage is applied between the X-electrode and the Y-electrode during driving of a display, opposed discharge occurs between the X-electrode and the Y-electrode, causing wall charge. Then, when voltages of opposite polarities are continuously applied to the Y-electrode and the Z-electrode, a predetermined potential difference is maintained between the Y electrode and the Z electrode by the wall charge, causing surface discharge.

Thus, as an ultraviolet ray is generated by the inert gas of the discharge region, the phosphor layer is excited by the ultraviolet ray to emit light for display of each pixel.

An operation of supplying power to each electrode of the related art plasma display device will now be described with reference to FIG. 1.

FIG. 1 is a block diagram of a structure of the related art plasma display device.

As shown therein, a plasma display device 100 includes a voltage generator 110, an X-board 120, a Y-board 130, a Z-board 140, and a video scan board 150 to supply power to each electrode.

The voltage generator 110 generates an address voltage, a scan voltage and a sustain voltage being supplied to an address electrode, a scan electrode and a sustain electrode, respectively. The generated address voltage is supplied to the X-board 120, and the X-board 120 outputs the address voltage to the address electrode. Also, the generated scan voltage is provided to the Y-board 130, and the Y-board 130 outputs the scan voltage to the scan electrode. In addition, the generated sustain voltage is supplied to the Z-board 140, and the Z-board 140 outputs the sustain voltage to the sustain electrode. The video scan board 150 controls the voltage generator 110 to allow the voltage generator 110 to transmit the address voltage, the scan voltage and the sustain voltage to the X, Y and Z boards 120, 130 and 140, respectively.

However, the related art plasma display device is problematic in that erroneous discharge occurs since power is simultaneously supplied to the X, Y and Z boards 120, 130 and 140 during initial driving of the plasma display device.

That is, variations in firing voltages between cells may occur because of problems caused by a process of manufacturing the plasma display panel employing a capacitor discharge principle. For this reason, although a black screen is supposed to be maintained during the initial driving of the display device, a noise caused by the faulty discharge in some of the cells may be disadvantageously displayed.

### SUMMARY OF THE INVENTION

Accordingly, the present invention is directed to a plasma display device and a method for driving the same that substantially obviate one or more problems due to limitations and disadvantages of the related art.

An object of the present invention is to provide a plasma display device and a method for driving the same capable of preventing faulty discharge occurring during initial driving by making a time when power is supplied to an address electrode different from a time when power is supplied to a sustain electrode during the initial driving.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a plasma display device including: an X-board outputting an address voltage to an address electrode; a Y-board outputting a scan voltage to a scan electrode; a Z-board outputting a sustain voltage to a sustain electrode; a power supply unit generating the address voltage, the scan voltage and the sustain voltage; and a power supply control unit controlling for transmitting the voltages to provide the voltages to at least each one of the X-board, the Y-board and the Z-board at a different time during an initial operation for the display device.

In another aspect of the present invention, there is provided a method for driving a plasma display device including one or more electrodes, the method including: generating an address voltage, a scan voltage and a sustain voltage transmitted to an X-board, Y-board and Z-board, respectively; transmitting the address voltage to the X-board; and controlling the scan voltage or the sustain voltage to be transmitted to the Y-board or the Z-board respectively when the predetermined delay time elapses after the address voltage is transmitted to the X-board.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a structure of a related art plasma display device;

FIG. 2 is a block diagram illustrating a structure of a plasma display device according to an embodiment of the present invention;

FIG. 3 is a block diagram illustrating a structure of a power supply controller of FIG. 2;

FIG. 4 is a graph showing timing of power supply to a board of the plasma display device according to an embodiment of the present invention; and

FIG. 5 is a flow chart showing a method for controlling power of the plasma display device according to an embodiment of the present invention.

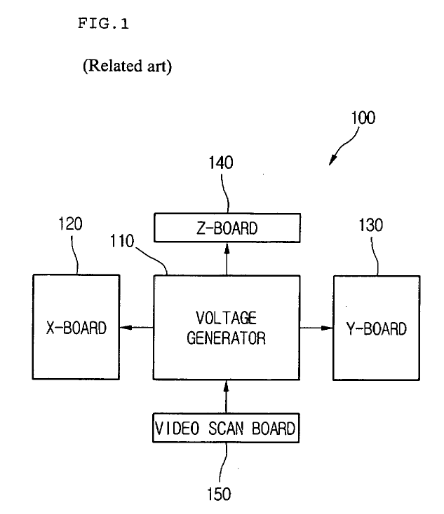

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

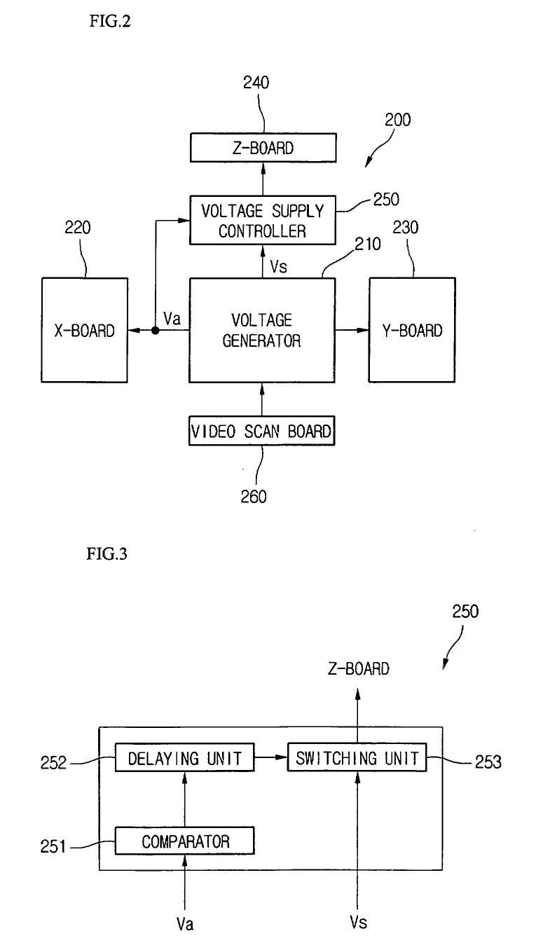

FIG. 2 is a block diagram illustrating a structure of a plasma display device according to an embodiment of the present invention. Although a power supply controller is installed only toward a Z-board in FIG. 2, the present invention is not limited thereto, but it is obvious that the power supply controller may be installed toward another board if necessary.

First, as illustrated in FIG. 2, a plasma display device 200 according to an embodiment of the present invention may include a voltage generator 210, an X-board 220, a Y-board 230, a Z-board 240, a power supply controller 250, and a video scan board 260 to provide power individually to an address electrode, a scan electrode, and a sustain electrode.

The voltage generator 210 generates an address voltage, a scan voltage, and a sustain voltage under control of the video scan board 260. Also, the generated address voltage is supplied to the X-board 220, the scan voltage is supplied to the Y-board 230, and the sustain voltage is supplied to the Z-board 240. The X-board 220 outputs the address voltage to an address electrode (hereinafter, referred to as an ‘X electrode’), the Y-board 240 outputs the scan voltage to a scan electrode (hereinafter, referred to as a ‘Y electrode’), and the Z-board 230 outputs the sustain voltage to a sustain electrode (hereinafter, referred to as a ‘Z electrode’).

To prevent faulty discharge that may occur during initial driving of the display device, power is supplied individually to the X-board 220, the Y-board 230, and the Z-board 240. To this end, power is provided to at least one of the boards at a different time. In controlling the supply of the power, the scan voltage is transmitted to the Y-board 230 when a predetermined delay time elapses after the address voltage is transmitted to the X-board, or the sustain voltage may be transmitted to the Z-board 240 when a predetermined delay time elapses after the address voltage is transmitted to the X-board 220. Otherwise, the scan voltage and the sustain voltage are transmitted to the Y-board 230 and the Z-board 240, respectively, when a predetermined delay time elapses after the address voltage is transmitted to the X-board 220.

In the structure depicted in FIG. 2, the power supply controller 250 is installed toward the Z-board 240 as an example, and controls a sustain voltage Vs to be transmitted to the Z-board 240 when a predetermined delay time elapses after an address voltage Va is supplied to the X-board 220.

Accordingly, during the initial driving of the plasma display device 200, the address voltage Va is supplied to the X-electrode first to reduce variations between cells of a panel employing a capacitor discharge principle. Then, the sustain voltage Vs is supplied to the Z electrode, thereby reducing initial faulty discharge.

A structure of the power supply controller 250 for controlling transmission of power will now be described with reference to FIG. 3.

FIG. 3 is a block diagram showing a structure of the power supply controller of FIG. 2. As illustrated, the power supply controller 250 may include a comparator 251, a delaying unit 252, and a switching unit 253.

The comparator receives an address voltage Va and compares a level of the address voltage Va with that of a predetermined reference voltage in order to determine whether or not a level of a voltage being supplied to the X-board 220 is normal. When the comparison result reveals that a normal voltage is supplied to the X-board 220, the comparator 251 outputs a comparison signal corresponding thereto. Specifically, when the level of the address voltage Va is gradually elevated to be equal to the level of the reference voltage, it is determined that a normal voltage is supplied to the X-board 220. The comparator 251 can activate and output the comparison signal when the level of the address voltage Va is equal to that of the reference voltage. In this case, the level of the reference voltage may be set to a level which is equal to a normal level of an address voltage Va.

The delaying unit 252 receives the activated comparison signal from the comparator 251, delays the comparison signal by a predetermined time, and outputs the delayed signal. The delaying unit 252 may be constructed in various manners, provided that it is able to delay a signal. As one example, the delaying unit 252 may include at least one delay element to delay a signal, or may include a timer and a switch to delay and output the signal by switching the switch when a predetermined delay time elapses.

The switching unit 253 receives a sustain voltage Vs, and is switched in response to the delayed signal outputted from the delaying unit 252 to control transmission of the sustain voltage Vs. Thus, the sustain voltage Vs is transmitted to the Z-board 240 when a predetermined delay time set by a user elapses after a normal voltage is supplied to the X-board 220.

As described above, in FIGS. 2 and 3, the power supply controller 250 is installed toward the Z-board 240, delays the sustain voltage Vs by the predetermined delay time, and then transmits the delayed signal to the Z-board 240. In contrast, if the power supply controller 250 is installed toward the Y-board 230, the power supply controller 250 may control a scan signal to be transmitted to the Y-board 230 when a predetermined delay time set by a user elapses after a normal voltage is supplied to the X-board 220.

A power supply operation of the plasma display device 200 having the aforementioned structure will now be described in detail.

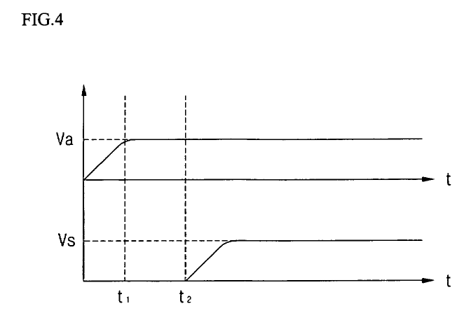

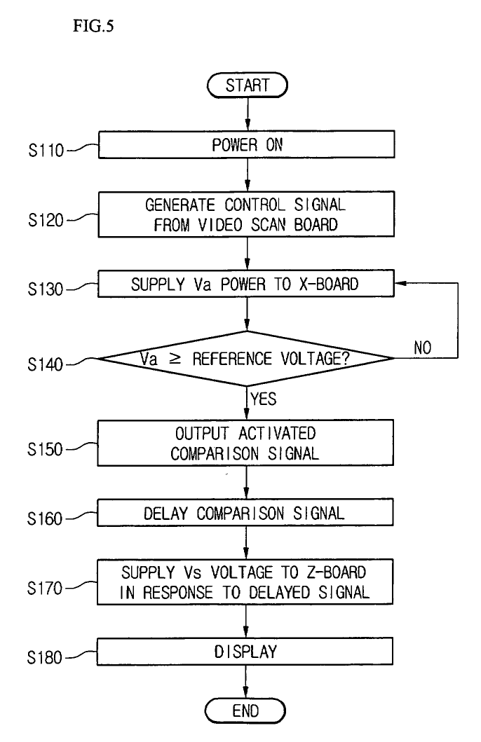

FIG. 4 is a view showing timing of power supply to a board of the plasma display device according to an embodiment of the present invention. As illustrated, an address voltage Va generated by a voltage generator 210 is inputted to the X-board 220, and reaches a normal state at the time ‘t₁’. Then, a sustain voltage Vs is supplied to the Z-board 240 when a predetermined delay time t₁-t₂ elapses after the address voltage Va reaches the normal state, that is, at the time ‘t₂’.

It is advantageous that the delay time t₁-t₂ is set as long as possible, in order to drive a panel upon sufficiently reducing variations between cells. Observation of a noise state caused by erroneous discharge through experiments shows that the delay time t₁-t₂ may be at least 10 msec. However, since an initial driving time is limited, the delay time t₁-t₂ may be set ranging from 10 msec to 15 msec.

When the arbitrarily set delay time t₁-t₂ elapses, the switching unit 253 provided to the power supply controller 250 is switched. When the power supply controller 250 is installed toward the Z-board 240, a sustain voltage is transmitted to the Z-board 240 by the switching. Also, when the power supply controller 250 is installed toward the Y-board 230, a scan voltage is transmitted to the Y-board 230 by the switching.

Accordingly, power is supplied to the Y-board 230 or the Z-board 240 in a state where variations between the cells of the panel are reduced, and therefore, faulty discharge during initial driving may be prevented. Also, since power is supplied to the Y-board 230 or the Z-board 240 after power of a normal level is supplied to the X-board 220, the variations between the cells may be further reduced.

Furthermore, power supply to the Y-board 230 or the Z-board 240 is temporarily cut off during the initial driving when a black screen is displayed, so that power can be saved.

A method for controlling the plasma display device according to an embodiment of the present invention will now be described with reference to FIG. 5.

FIG. 5 is a flow chart showing a method for controlling power of the plasma display device according to an embodiment of the present invention. In FIG. 5, an embodiment in which power is supplied to the Z-board when a predetermined delay time elapses after power is supplied to the X-board is described as an example. Accordingly, the Y-board may receive power simultaneously with the X-board without a time delay.

As illustrated, when power is supplied to the plasma display device by a user (S110), the video scan board generates a control signal for controlling the voltage generator (S120). Then, the voltage generator generates an address voltage, a scan voltage, and a sustain voltage supplied to the X-board, the Y-board and the Z-board.

When those voltages are generated, the address voltage is transmitted to the X-board (S130). In this case, the sustain voltage being transmitted to the Z-board is cut off by a switch, and thus is not transmitted to the Z-board.

Also, the address voltage is supplied also to the power supply controller, and the power supply controller compares the address voltage with a predetermined reference voltage (S140). The predetermined reference voltage may be set to the same level as a level when the address voltage reaches a normal voltage. When the comparison result reveals that the address voltage is the same as or higher than the level of the reference voltage, a comparison signal is activated and outputted (S150).

The activated comparison signal is provided to the delaying unit, and thus is delayed by a predetermined time (S160). The time by which the comparison signal is delayed may be about 10 msec to 15 msec as described above.

When the activated comparison signal is delayed by the delay time and is outputted, the switch cutting off the transmission of the sustain voltage is turned ON by the delayed signal. Accordingly, the sustain voltage is supplied to the Z-board (S170).

When the initial driving period is over under control as described above, an image is displayed in response to a power supply control signal synchronized with an inputted image signal and outputted from the video scan board (S180).

Accordingly, in the plasma display device and a method of driving the same according to an embodiment of the present invention, a time when power is supplied to the address voltage is made to be different from a time when power is supplied to the scan electrode or the sustain electrode during the initial driving of the plasma display device. Accordingly, faulty discharge that might occur during the initial driving can be prevented, and power consumption of the device can be reduced.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A plasma display device comprising:
an X-board outputting an address voltage to an address electrode;
a Y-board outputting a scan voltage to a scan electrode;
a Z-board outputting a sustain voltage to a sustain electrode;
a power supply unit generating the address voltage, the scan voltage and the sustain voltage; and
a power supply control unit controlling for transmitting the voltages to provide the voltages to at least each one of the X-board, the Y-board and the Z-board at a different time during an initial operation for the display device.

2. The device according to claim 1, wherein the power supply control unit controls a voltage delayed by a predetermined delay time to be transmitted to at least one of the X-board, the Y-board and the Z-board.

3. The device according to claim 2, wherein the power supply control unit controls the scan voltage to be transmitted to the Y-board when the predetermined delay time elapses after the address voltage is transmitted to the X-board.

4. The device according to claim 2, wherein the power supply control unit controls the sustain voltage to be transmitted to the Z-board when the predetermined delay time elapses after the address voltage is transmitted to the X-board.

5. The device according to claim 2, wherein the power supply control unit controls the scan voltage and the sustain voltage to be transmitted to the Y-board and the Z-board, respectively, when the predetermined delay time elapses after the address voltage is transmitted to the X-board.

6. The device according to claim 1, wherein the power supply control unit comprises:
a comparator receiving the address voltage and comparing a level of the address voltage with that of a reference voltage;
a delaying unit receiving a comparison signal from the comparator, delaying the comparison signal by a predetermined time, and outputting the delayed signal; and
a switching unit controlling transmission of at least one of the scan voltage and the sustain voltage by switching in response to the delayed signal outputted from the delaying unit.

7. The device according to claim 6, wherein the comparator activates the comparison signal when the level of the address voltage is equal to that of the reference voltage, and outputs the activated comparison signal.

8. The device according to claim 7, wherein the switching unit is switched in response to the activated comparison signal delayed by the predetermined time.

9. A method for driving a plasma display device including one or more electrodes, the method comprising:
generating an address voltage, a scan voltage and a sustain voltage transmitted to an X-board, Y-board and Z-board, respectively;
transmitting the address voltage to the X-board; and
controlling the scan voltage or the sustain voltage to be transmitted to the Y-board or the Z-board respectively when the predetermined delay time elapses after the address voltage is transmitted to the X-board.

10. The method according to claim 9, wherein the controlling step controls the scan voltage to be transmitted to the Y-board when the predetermined delay time elapses after the address voltage is transmitted to the X-board.

11. The method according to claim 9, wherein the controlling step controls the sustain voltage to be transmitted to the Z-board when the predetermined delay time elapses after the address voltage is transmitted to the X-board.

12. The method according to claim 9, wherein the controlling step controls the scan voltage and the sustain voltage to be transmitted to the Y-board and the Z-board, respectively, when the predetermined delay time elapses after the address voltage is transmitted to the X-board.

13. The method according to claim 9, wherein the controlling step comprises,
outputting a comparison signal by comparing a level of the address voltage with that of a reference voltage;
delaying the comparison signal by a predetermined time; and
transmitting the scan voltage or the sustain voltage to the Y-board or the Z-board respectively, in response to the delayed comparison signal.

14. The method according to claim 13, wherein the outputting of the comparison signal comprises activating the comparison signal when the level of the address voltage is equal to that of the reference voltage, and then outputting the activated comparison signal.

15. The method according to claim 14, wherein the transmitting of the voltage comprises switching to transmit the scan voltage to the Y-board in response to the activated comparison signal delayed by the predetermined time.

16. The method according to claim 14, wherein the transmitting of the voltage comprises switching to transmit the sustain voltage to the Z-board in response to the activated comparison signal delayed by the predetermined time.
